(19) United States
(12) Patent Application Publication
(10) Pub. No.: US 2024/0279858 A1
(43) Pub. Date: Aug. 22, 2024

(54) NONWOVEN MATERIAL ADAPTED FOR HIGH EFFICIENCY AIR FILTRATION

(71) Applicant: North Carolina State University, Raleigh, NC (US)

(72) Inventor: Behnam Pourdeyhimi, Cary, NC (US)

(21) Appl. No.: 18/444,129

(22) Filed: Feb. 16, 2024

Related U.S. Application Data
(60) Provisional application No. 63/446,456, filed on Feb. 17, 2023.

(51) Int. Cl. D04H 13/00; B01D 29/03; D01F 6/06; D01F 8/14

(52) U.S. Cl. CPC D04H 13/005; B01D 29/031; D01F 6/06; D01F 8/14; B01D 2201/12; B01D 2221/00; B01D 2239/064

(57) ABSTRACT

The present disclosure provides a nonwoven material including a blend of a first plurality of monocomponent fibers and a second plurality of segmented fibers having segments of a first polymer and segments of a second polymer different from the first polymer, wherein the nonwoven material includes about 75 to about 95% by weight of the monocomponent fibers, and about 5 to about 25% by weight of the segmented fibers, based on the total weight of the nonwoven material, and wherein the segmented fibers are at least partially fibrillated or split. An air filter including the nonwoven material is also provided.

### CROSS-REFERENCE TO RELATED APPLICATIONS

The present application claims priority to and the benefit of U.S. Provisional Application No. 63/446,456 filed Feb. 17, 2023, the disclosure of which is incorporated herein by reference in its entirety.

### STATEMENT REGARDING FEDERALLY SPONSORED RESEARCH OR DEVELOPMENT

This invention was made with government support under grant number 70NANB21H085 awarded by the National Institute of Standards & Technology (NIST). The government has certain rights in the invention.

### FIELD OF THE INVENTION

The present disclosure relates to a nonwoven material suitable for use in filtration.

### BACKGROUND OF THE INVENTION

Since SARS-CoV-2 viral particles spread between people more readily indoors than outdoors, the Centers for Disease Control and Prevention recommend improvements to building ventilation as part of a layered approach to reducing exposure to the virus. One of the suggested improvements is to increase air filtration without significantly reducing design airflow.

Filtration efficiency of filters for Heating, Ventilation and Air Conditioning (HVAC) systems is often tested using the ANSI/ASHRAE Standard 52.2-2017 (Method of Testing General Ventilation Air-Cleaning Devices for Removal Efficiency by Particle Size), which provides a rating known as the Minimum Efficiency Reporting Value or MERV. A higher MERV value denotes a higher filtration efficiency. Many HVAC pleated filters used in residential systems are in the 5-8 MERV range, while typical commercial HVAC systems use filters with a 9-12 MERV rating. However, to capture viral particles, a MERV rating of 13 or higher is needed.

Attempting to switch all commercial HVAC systems to MERV 13 or higher-rated filters is complicated by several factors. For example, many buildings are equipped with smaller ducts and under-powered fan systems that cannot accommodate the higher pressure drop associated with many commercially-available MERV 13 filters. Additionally, the SARS-CoV-2 pandemic has caused a significant shortage of high efficiency filters.

There remains a need in the art for new sources of high efficiency filtration media.

### SUMMARY OF THE INVENTION

The present disclosure relates to nonwoven materials that include a blend of predominately monocomponent fibers with a minority component of segmented fibers. At least a portion of the segmented fibers are at least partially split to produce smaller fibrils. In certain embodiments, the combination of the larger monocomponent fibers with the smaller fibrils can provide high filtration efficiency at acceptable pressure drop levels. In certain embodiments, the present disclosure related to nonwoven materials that offer both high filtration efficiency and lower pressure drop than commercially-available filtration media.

The disclosure includes, without limitation, the following embodiments.

Embodiment 1: A nonwoven material comprising a blend of a first plurality of monocomponent fibers and a second plurality of segmented fibers comprising segments comprising a first polymer and segments comprising a second polymer different from the first polymer, wherein the nonwoven material comprises about 75 to about 95% by weight of the monocomponent fibers, and about 5 to about 25% by weight of the segmented fibers, based on the total weight of the nonwoven material, and wherein the segmented fibers are at least partially fibrillated or split.

Embodiment 2: The nonwoven material of Embodiment 1, wherein the first polymer is an aliphatic polyester and the second polymer is an aromatic polyester or a polyolefin, or the first polymer is a polyolefin and the second polymer is a polyamide.

Embodiment 3: The nonwoven material of Embodiment 1 or Embodiment 2, wherein the first polymer is polylactic acid and the second polymer is polypropylene or polyethylene.

Embodiment 4: The nonwoven material of any one of Embodiments 1 to 3, wherein the weight ratio of the first polymer to the second polymer within the segmented fibers is 1:10 to 10:1.

Embodiment 5: The nonwoven material of any one of Embodiments 1 to 4, wherein the monocomponent fibers comprise either the first polymer or the second polymer.

Embodiment 6: The nonwoven material of any one of Embodiments 1 to 5, wherein the monocomponent fibers comprise polypropylene or polyethylene.

Embodiment 7: The nonwoven material of any one of Embodiments 1 to 6, wherein the segmented fibers are segmented ribbon, segmented pie, tipped multilobal, or segmented cross fibers.

Embodiment 8: The nonwoven material of any one of Embodiments 1 to 7, wherein the segmented fibers are segmented pie fibers having 2 to about 64 segments.

Embodiment 9: The nonwoven material of any one of Embodiments 1 to 8, wherein the segmented fibers are segmented pie fibers having about 10 to about 30 segments.

Embodiment 10: The nonwoven material of any one of Embodiments 1 to 9, wherein the nonwoven material has a basis weight of about 50 to about 300 g/m² and/or a pressure drop of about 5 to about 80 Pa and/or a filtration efficiency of about 80% or higher, on a TSI 8130 filter tester at a flow rate of 32 L/min and a sample area of 100 cm².

Embodiment 11: The nonwoven fabric of any one of Embodiments 1 to 10, wherein the monocomponent fibers and the segmented fibers are continuous filament fibers.

Embodiment 12: The nonwoven fabric of any one of Embodiments 1 to 11, wherein the monocomponent fibers and the segmented fibers are discontinuous fibers having a length ranging from 3 mm to 150 mm.

Embodiment 13: An air filter comprising the nonwoven material of any one of Embodiments 1 to 12.

Embodiment 14: The air filter of Embodiment 13, wherein the nonwoven material is pleated, optionally wherein the nonwoven material has about 10 to about 25 pleats/ft.

Embodiment 15: The air filter of Embodiment 13 or Embodiment 14, wherein the air filter further comprises a frame attached to the nonwoven material.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this brief summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### DESCRIPTION OF THE DRAWINGS

Having thus described the present disclosure in general terms, reference will now be made to the accompanying drawings, which are not necessarily drawn to scale, and wherein:

FIGS. 1A and 1B are schematic perspective views of example bicomponent segmented pie fibers, solid (FIG. 1A) and hollow (FIG. 1B);

FIGS. 2A-2C are schematic cross-sectional views of further examples of bicomponent segmented fibers, including a segmented ribbon fiber (FIG. 2A), a segmented cross fiber (FIG. 2B), and a tipped trilobal fiber (FIG. 2C);

FIG. 3 is a schematic perspective view of an air filtration filter assembly according to one example embodiment of the present disclosure;

FIG. 4 is a scanning electron microscope (SEM) image with magnification at 175× for a carded staple nonwoven of Example 1; and

FIG. 5 is a scanning electron microscope (SEM) image with magnification at 350× for a spunbond nonwoven of Example 2.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Directional terms, such as “forward,” “rearward,” “front,” “back,” “right,” “left,” “upwardly,” “downwardly,” and the like are words of convenience and are not to be construed as limiting terms.

As used herein, the term “fiber” is defined as a basic element of nonwovens which has a high aspect ratio of, for example, at least about 100 times. In addition, “filaments/continuous filaments” are continuous fibers of extremely long lengths that possess a very high aspect ratio. “Staple fibers” are cut lengths from continuous filaments. Therefore, as used herein, the term “fiber” is intended to include fibers, filaments, continuous filaments, staple fibers, and the like. The term “multicomponent fibers” refers to fibers that comprise two or more components that are different by physical or chemical nature, including bicomponent fibers.

The term “nonwoven” as used herein in reference to fibrous materials, webs, mats, batts, or sheets refers to fibrous structures in which fibers are aligned in an undefined or random orientation. The nonwoven fibers are initially presented as unbound fibers or filaments, which may be natural or man-made. An important step in the manufacturing of nonwovens involves binding the various fibers or filaments together. The manner in which the fibers or filaments are bound can vary, and include thermal, mechanical and chemical techniques that are selected in part based on the desired characteristics of the final product. Nonwoven fabrics or webs have been formed from many processes, which include carding, meltblowing, spunbonding, and air or wet laying processes.

As used herein, the terms “hydroentangle” or “hydroentangling” refers to a process by which a high velocity water jet or even an air jet is forced through a web of fibers causing them to become randomly entangled. Hydroentanglement can also be used to impart images, patterns, or other surface effects to a nonwoven fabric by, for example, hydroentangling the fibers on a three-dimensional image transfer device such as that disclosed in U.S. Pat. No. 5,098,764 to Bassett et al. or a foraminous member such as that disclosed in U.S. Pat. No. 5,895,623 to Trokhan et al., both fully incorporated herein by reference for their teachings of hydroentanglement.

### Nonwoven Fabric

The nonwoven fabrics of the present disclosure are formed of a blend of monocomponent fibers with bicomponent fibers. The combined blend of fibers comprises two or more dissimilar polymer materials. It is advantageous to select polymers with dissimilar effective charge density (Ge), which can be calculated in units of nC/cm² as set forth in, for example, Liu et al., Triboelectric charge density of porous and deformable fabrics made from polymer fibers, Nano Energy, Volume 53, 2018, Pages 383-390, and particularly advantageous to pair a polymer having a positive effective charge density with a polymer having a negative effective charge density. For example, as can be seen from the cited reference, fabrics made from aliphatic polyesters such as polylactic acid (PLA) or nylon (polyamide) have a relatively high positive effective charge density (e.g., in the range of about 0.3 to about 0.9 nC/cm²), while fabrics made from polyolefins, such as polyethylene (PE) or polypropylene (PP), or aromatic polyesters, such as polyethylene terephthalate (PET), have a negative effective charge density (e.g., in the range of about −0.1 to about −1.3 nC/cm²). The fibers of the nonwoven material can be continuous filaments or staple fibers.

Thus, in certain embodiments, the nonwoven fabric of the present disclosure comprises at least one polymer having a positive effective charge density and at least one polymer having a negative effective charge density, each of the polymers typically selected from among thermoplastic polymers selected from the group consisting of polyesters, polyamides, thermoplastic copolyetherester elastomers, polyolefins, polyacrylates, and thermoplastic liquid crystalline polymers. Example polymer pairings include an aliphatic polyester with a polyolefin, a nylon with a polyolefin, an aliphatic polyester with an aromatic polyester, or a nylon with an aliphatic polyester.

Example aliphatic polyesters include polyglycolic acid (PGA), polylactic acid (PLA), polycaprolactone (PCL), polyethylene adipate (PEA), polybutylene succinate (PBS), polyhydroxyalkanoates (PHA), and copolymers or combinations thereof. Example polyhydroxyalkanoates (PHA) include polyhydroxybutyrate (PHB), poly(3-hydroxybutyrate-co-3-hydroxyvalerate) (PHBV), and copolymers or combinations thereof. Example aromatic polyesters include polyethylene terephthalate (PET), polytrimethylene terephthalate (PTT), polybutylene terephthalate (PBT), and copolymers or combinations thereof. Example nylons include nylon 6, nylon 6/6, nylon 6,6/6, nylon 6/10, nylon 6/11, nylon 6/12, nylon 11, nylon 12, and copolymers or combinations thereof. PLA resin for forming fibers can be sourced from, for example, Nature Works of Plymouth, MN. Polyolefin resins for forming fibers can be sourced from, for example, Exxon Mobil Corporation of Irving, TX.

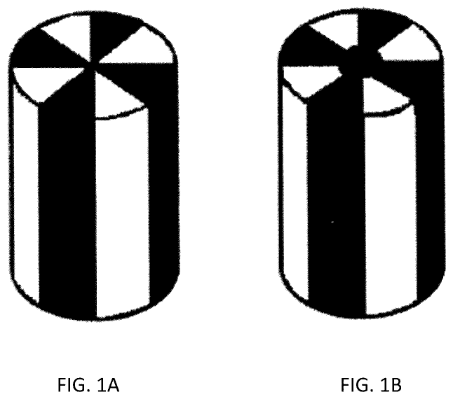

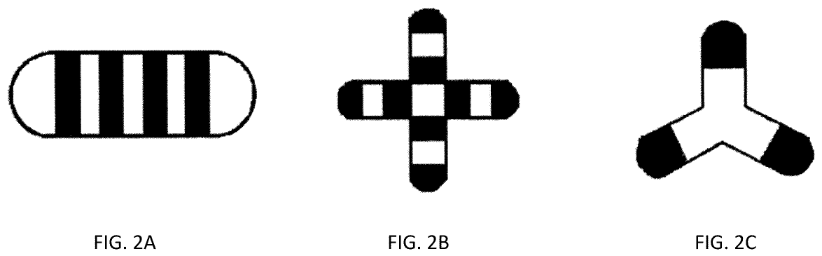

In certain embodiments, the two dissimilar polymer components are combined in the bicomponent fibers of the nonwoven material of the present disclosure. The bicomponent fibers are typically segmented fibers (e.g., segmented ribbon, segmented pie, segmented cross, and the like). Example segmented fibers are set forth in FIGS. 1A, 1B, and 2A-2C. Segmented pic (i.e., pie-wedge) fibers are shown in FIGS. 1A and 1B, and such fibers can be solid (FIG. 1A) or hollow (FIG. 1B). Further examples of segmented fibers include segmented ribbon fibers (FIG. 2A), segmented cross fibers (FIG. 2B), and tipped multilobal fibers (FIG. 2C). The number of segments within the segmented fiber can vary, with example ranges including 2 to about 64 segments, or 10 to about 30 segments, or 12 to about 20 segments. The bicomponent fibers can be characterized by the weight ratio of the two dissimilar polymer components within the fiber, with example weight ratios being 1:10 to 10:1, such as 1:9 to about 9:1, or about 1:8 to about 8:1, or about 1:5 to about 5:1, or about 1:3 to about 3:1.

The monocomponent fiber portion of the nonwoven fabric is typically constructed of one of the polymer materials set forth above. Typically, the polymer selected for the monocomponent fibers is one of the two polymers utilized in the bicomponent fibers. In certain examples, the monocomponent fibers comprise a polyolefin, such as polyethylene (PE) or polypropylene (PP), and the bicomponent fibers comprise the same polyolefin and an aliphatic polyester such as polyglycolic acid (PGA), polylactic acid (PLA), polycaprolactone (PCL), polyethylene adipate (PEA), polybutylene succinate (PBS), polyhydroxyalkonoates (PHA), and copolymers or combinations thereof.

Both the monocomponent and the bicomponent fibers can have any type of cross-section, including, but not limited to, circular, rectangular, square, oval, triangular, and multilobal. In certain embodiments, the fibers can have one or more void spaces, wherein the void spaces can have, for example, circular, rectangular, square, oval, triangular, or multilobal cross-sections.

The bicomponent fibers will be partially or fully split. Such structures provide strong filtration efficiency performance at relatively low pressure drop levels. As used herein, “fibrillation/fibrillate” or “split/splitting” refer to at least partially breaking down a nonwoven web comprising the bicomponent fibers into fibrils through the application of mechanical energy, resulting in at least partial separation and intertwining of the components of the bicomponent fibers. Confirmation of at least partial fibrillation or splitting of a nonwoven web of bicomponent fibers can be accomplished by visual inspection of Scanning Electron Microscopy (SEM) micrographs. Although not bound by a particular theory of operation, it is also believed that the fibrillation or splitting can impart a certain level of electrostatic charge to the nonwoven structure in certain embodiments, which may enhance filtration efficiency.

The polymeric components of the fibers of the disclosure can optionally include other components or materials not adversely affecting the desired properties thereof. Exemplary materials that can be present include, without limitation, antioxidants, stabilizers, surfactants, waxes, flow promoters, solid solvents, particulates, pigments, and other materials added to enhance processability or end-use properties of the polymeric components. Such additives can be used in conventional amounts.

Additionally, one or more charge stabilizer additives adapted to increase filtration efficiency and enhance longevity of the surface charge of the fabric can be added to one or more of the polymers that form the nonwoven material. Example additives include metal salts of fatty acids such as stearic acid (e.g., magnesium, zinc, or aluminum stearate), titanate salts such as alkaline earth metal titanate salts (e.g., barium titanate or perovskite), silicate salts such as tourmaline, and other mineral materials such as perlite. When present, the amount of this type of additive is typically in the range of less than about 10% by weight of the overall fiber composition, such as less than about 7.5% or less than about 5% (e.g., about 0.1 to about 10% by weight or about 0.1 to about 5% by weight).

Fibers for use according to the present disclosure can have diameters ranging from about 0.1 μm to about 75 μm. Monocomponent fibers may have diameters of at least about 4 μm, at least about 5 μm, at least about 6 μm, at least about 8 μm, at least about 10 μm, at least about 12 μm, or at least about 15 μm. Monocomponent fibers can particularly have diameters in the range of about 10 μm to about 40 μm, about 15 μm to about 35 μm, or about 20 μm to about 30 μm. Similarly, bicomponent fibers prior to disassociation can have diameters in the range of 10 μm to about 30 μm, about 12 μm to about 25 μm, or about 15 μm to about 20 μm.

In certain embodiments, the fabric can be characterized by the weight percentage of the monocomponent fibers present, relative to the total weight of the fabric. Specifically, a fabric according to the present disclosure can comprise at least 75% by weight, at least 78%, at least 80%, at least 82%, at least 84%, at least 86%, at least 88%, or at least 90% by weight of the monocomponent fiber, with the remainder being the bicomponent fiber component (or fibrils disassociated therefrom). In certain embodiments, the monocomponent fiber may comprise about 75% to about 95% by weight or about 80% to about 90%, by weight of the overall fabric. The monocomponent fibers add strength and cohesiveness to the material, and also help maintain a reasonable pressure drop.

Beneficially, the bicomponent fibers of the disclosure can be disassociated to form fibers having much smaller diameters. For example, segmented fibers (e.g., pic/wedge fibers) can be disassociated into individual filaments/fibrils having diameters in the range of about 0.5 μm to about 5 μm, about 0.5 μm to about 4 μm, about 0.5 μm to about 3 μm, or about 0.5 μm to about 2 μm. In certain embodiments, following dissociation of the bicomponent fibers, the resulting nonwoven material or fabric will contain up to about 25% by weight of fibrils in the above-noted size range, such as about 5 to about 25% by weight of such fibrils, or about 10% to about 20% by weight, based on the weight of the overall fabric.

Nonwoven fabrics according to the present disclosure can be characterized, in some embodiments, in terms of the ratios of the polymers used in preparing the fabrics. For example, a fabric could be formed using a bicomponent fiber formed of polymer A and polymer B and using a monocomponent fiber formed of polymer A or polymer B. When only two polymers are used in preparing a mixed fiber nonwoven fabric according to the disclosure, the ratio of polymer A (e.g., PLA) to polymer B (e.g., PE or PP) in the overall nonwoven material can be about 1:1 to about 1/99, based on the overall weight of the polymers. In further embodiments, the polymer ratio can be about 1:1 to about 1:10, about 1:2 to about 1:9, about 1:3 to about 1:8, or about 1:4 to about 1:7.

In some embodiments, the basis weight of the nonwoven web is about 200 g/m² or less, about 175 g/m² or less, about 150 g/m² or less, about 125 g/m² or less, about 100 g/m² or less, or about 75 g/m² or less. In certain embodiments, the nonwoven fabric has a basis weight of about 75 g/m² to about 200 g/m², such as about 100 to about 150 g/m². Multiple layers can be used if desired in the nonwoven structure, with a total basis weight of about 200 g/m² or greater, about 225 g/m² or greater, or about 250 g/m² or greater (e.g., a range of about 200 to about 300 g/m²). The basis weight of the fabric can be measured, for example, using test methods outlined in ASTM D 3776/D 3776M-09ae2 entitled “Standard Test Method for Mass Per Unit Area (Weight) of Fabric.” This test reports a measure of mass per unit area and is measured and expressed as grams per square meter (i.e., gsm or g/m²).

Certain embodiments of the nonwoven fabric have a filtration efficiency of about 75% or higher, or about 80% or higher, or about 85% or higher, or about 90% or higher, or about 95% or higher, or about 97% or higher (e.g., about 75% to about 99% or about 80% to about 95%), measuring at a flow rate of 32 L/min and a sample area of 100 cm² (face velocity of 5.3 cm/s) on a Model 8130 Automated Filter Tester manufactured by TSI Incorporated. Example ranges of pressure drop for certain example embodiments of the nonwoven fabric include about 80 Pa or less, or about 75 Pa or less, or about 70 Pa or less, or about 65 Pa or less, such as a range of about 5 to about 75 Pa or about 10 to about 65 Pa, measured at a flow rate of 32 L/min and a sample area of 100 cm². These are the initial pressure drop values.

### Method of Making Nonwoven Material

The nonwoven materials of the present disclosure can be formed by various processes, depending in part on whether continuous filaments or staple fibers are used. In certain embodiments, discontinuous fiber webs are formed via a staple fiber process such as airlay, wetlay, carding, or a combination thereof. Such staple fiber webs can be bonded by, for example, needle punching.

In certain advantageous embodiments, the nonwoven material is formed using a spunbond process with continuous filament fibers. Such a process can provide higher production throughput than staple fiber processes. In a typical spunbond process, at least two different polymer hoppers provide a melt-extrudable polymer that is filtered and pumped through a spin pack that combines the polymers in the desired cross-sectional multicomponent configuration. The molten fibers are then quenched with air, attenuated or drawn down, and deposited on a moving belt to form a fiber web. In certain embodiments, the mixed fibers will be spun and extruded simultaneously using the same spin beam. Alternatively, the fibers may be extruded simultaneously using different spin beams. Thereafter, the nonwoven web is subjected to one or more bonding operations, such as hydroentangling, needlepunching, thermal bonding, and the like.

For purposes of the present disclosure, it is advantageous for the bonding process to include hydroentangling, which also causes the fibrillation or splitting of bicomponent fibers within the nonwoven web. A typical hydroentangling system will include a drum entangler using, for example, two drums and four injectors. A pre-wet injector/manifold may be used as well, and there may be more drums and injectors used. In some embodiments, the surface of the drum used in hydroentangling is smooth to enhance the separation of the fibrils after fibrillation or splitting. A typical hydroentangling process can include subjecting both sides of a fiber web to water pressure from multiple hydroentangling manifolds, although the process can also include the impingement of water on only one side.

In certain embodiments, the first surface is exposed to water pressure from one or more hydroentangling manifolds. In other embodiments, the first surface and second surface are exposed to water pressure from one or more hydroentangling manifolds. The one or more hydroentangling manifolds can have a water pressure from 10 bars to 1000 bars. Example water pressure used for hydroentanglement can be from 10 bars and 500 bars. In certain embodiments, the water pressure used for hydroentanglement is from 10 bars to 100 bars, 10 bars to 200 bars, 10 bars to 300 bars, 10 bars to 400 bars, 10 bars to 600 bars, 100 bars to 200 bars, 300 bars to 400 bars, 500 bars to 600 bars, 600 bars to 700 bars, 700 bars to 800 bars, 800 bars to 900 bars, 900 bars to 1000 bars, or 500 bars to 1000 bars. In certain embodiments, the water pressure used for hydroentanglement is from 10 bars to 300 bars. In additional embodiments, a series of injectors or manifolds are used, and the pressure is gradually increased.

In certain embodiments, the hydroentangling manifold water jets are spaced at least 1200 microns away from each other. In some other examples, the water jets are spaced from 1200 microns to 4800 microns apart, e.g., from 1200 microns to 1800 microns, 1200 microns to 2400 microns, 1800 microns to 2400 microns, 1800 microns to 2400 microns, or 2400 microns to 4800 microns apart. Each water jet spacing pertains to one manifold. In certain embodiments, for the disclosed method, 3, 4, 5, or 6 manifolds can be used. In other embodiments, more than 6 manifolds can be used.

In some embodiments, hydroentangling can use multiple manifolds where the spacing of the water jets increases or decreases from the first manifold or set of manifolds to the last manifold or set of manifolds. For example, at least 3, 4, or 5 manifolds can have jet spaced at least 2400 microns apart where the rest are less than 2400 microns apart. In additional embodiments, 7 manifolds can be used with one or two having water jets spaced 1200 microns apart and at least four of the water jets being spaced at least 2400 microns apart.

Hydroentangling can lead to partial fibrillation or splitting of the bicomponent filaments/fibers. The partial fibrillation or splitting allows for a low-density material with a low pressure drop while keeping a high efficiency. The structure of the material is made up of fine fibrils and larger fibers. Partial fibrillation or splitting can result, for example, in about 50% of the fibers being fibrillated or split. This can be determined by SEM micrographs. In some examples, from 80% to 10% of the fibers are fibrillated or split, e.g., 70%, 60%, 50%, 40%, 30%, 20%, or 10%, where any value can form the upper or lower endpoint of a range, can be fibrillated or split as determined by SEM micrographs.

It is believed that nonwoven fabrics with particularly advantageous surface charging can be made from bicomponent fibers fibrillated or split with a certain minimum amount of energy. The energy imparted to the fibers during hydroentanglement or other bonding processes not only entangles the fibers into a cohesive web, but also causes sufficient friction between the dissimilar polymer materials to cause significant surface charging. It is advantageous for the hydroentangling pressure introduced during hydroentanglement or other bonding processes to exceed about 50 bar, such as about 100 bar to about 250 bar. This level of energy typically requires multiple manifolds, such as hydroentanglement systems with greater than 2, greater than 3, greater than 4, greater than 5, or greater than 6 manifolds (e.g., 4 to 10 manifolds or 4 to 9 manifolds or 5 to 8 manifolds).

When thermal bonding (such as calendaring) is used as part of the bonding process, such thermal bonding can be carried out at a variety of temperatures. In some embodiments, thermal bonding is carried out at a temperature of about 80° C. to about 200° C., about 90° C. to about 180° C., about 100° C. to about 170° C., about 110° C. to about 170° C., or about 120° C. to about 170° C.

Methods for nonwoven production that can be adapted for use in the present disclosure are described in US Publ. Appl. No. 2020/0270787 to Pourdeyhimi, PCT Publ. No. WO2013/103844 to Pourdeyhimi et al., as well as in U.S. Pat. No. 7,981,226 to Pourdeyhimi et al.; U.S. Pat. No. 7,883,772 to Pourdeyhimi et al.; U.S. Pat. No. 7,981,336 to Pourdeyhimi, and U.S. Pat. No. 8,349,232 to Pourdeyhimi et al., all of which are incorporated by reference herein.

The nonwoven web, or a portion or layer thereof, can be treated to induce additional electrostatic charge within the fibrous material, which enhances filtration efficiency and dust collection of the material. Electric charge can be imparted to the fibers by various methods including, but not limited to, corona charging, tribocharging, hydrocharging, and plasma fluorination. See, for example, the electric charging techniques set forth in U.S. Pat. No. 4,215,682 to Kubik et al.; U.S. Pat. No. 4,588,537 to Klasse et al.; U.S. Pat. No. 4,798,850 to Brown; U.S. Pat. No. 5,401,446 to Tsai et al.; U.S. Pat. No. 6,119,691 to Angadjivand et al.; and U.S. Pat. No. 6,397,458 to Jones et al., all of which are incorporated by reference herein. In one particular embodiment, the fibrous material is charged using corona charging by treating one or both sides of the nonwoven web with charging bars, such as those available from Simco-Ion, which can be placed close to the surface of the nonwoven web (e.g., about 20 to about 60 mm) and operating at a voltage of about 35 to about 50 kV.

### Filtration Media

The nonwoven materials of the present disclosure are suitable for use in air filtration. The nonwoven materials can be pleated for such use. The pleated fabric structures are typically formed from the nonwoven web through use of a combination of heat and pressure, using pleating techniques such as solid phase pressure forming, vacuum pleating, bladder pleating, match plate pleating, stamping, pressing, calendaring and the like. The pleat frequency can vary, with example ranges including about 10 to about 25 pleats/ft or about 15 to about 20 pleats/ft. Pleating processes that can be adapted for use in the disclosure are described, for example, in U.S. Pat. No. 7,060,344 to Pourdeyhimi et al., which is herein incorporated by reference in its entirety.

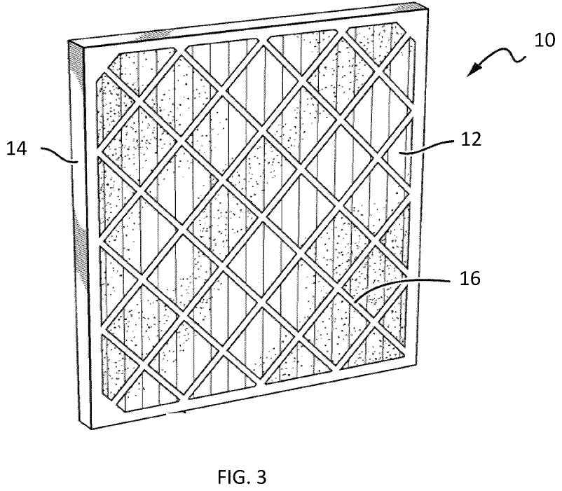

A filter structure can be formed by, for example, by combining the pleated nonwoven structure with a metal mesh (before or after pleating) and a cardboard frame to add additional strength to the structure. FIG. 3 illustrates an exemplary embodiment 10 of an HVAC system air filter according to the present disclosure. The HVAC system air filter 10 generally comprises a filter medium 12 within a supportive frame 14. The supportive frame 14 is configured to orient the HVAC system air filter 10 within the HVAC system such that the return air stream is directed through the filter medium 12. As such, the supportive frame 14 comprises a shape and size suitable for supporting the HVAC system air filter 10 within the HVAC system. It will be appreciated that the shape and size of the supportive frame 14 will vary depending upon a make and model of the HVAC system for which the air filter 10 is intended to be used.

The supportive frame 14 may comprise various fastening or supportive structures and materials suitably configured for securing the HVAC system air filter 10 within a particular HVAC system and to secure the filter medium 12 to the supportive frame. To this end, in the embodiment illustrated in FIG. 3, the supportive frame 14 comprises a grate 16 configured to support the filter medium 12 within the air filter 10. As noted above, the filter medium 12 can comprise multiple layers of the nonwoven material set forth herein, which can be attached together using any fastening method known in the art, including stitching, lamination, and adhesive bonding.

### EXPERIMENTAL

### Example 1—Staple Fiber Carded Webs

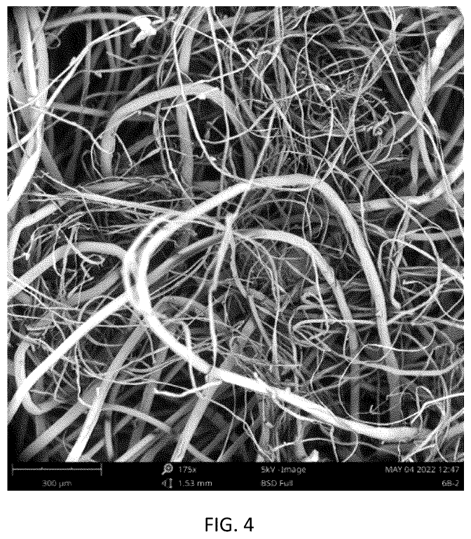

Polypropylene monocomponent staple fibers (30 micron) were combined with bicomponent segmented pie fibers (20 micron before splitting) consisting of 16 alternating segments of polypropylene and polylactic acid (50/50% of each by weight) to form a nonwoven web prepared by carding, crosslapping, and needle punching. The nonwoven web had a basis weight of 125 g/m² with 20% by weight of the segmented pie fibers, with the remainder being polypropylene monocomponent fibers. Three nonwoven webs were prepared, with one of the three prepared at a higher needling density (Sample 1). The needling density was kept at 60/cm² with a needle penetration of 12 mm by using a single barb conical needle. An SEM image of the resulting nonwoven is shown in FIG. 4 for Sample 2, while others showed similar behavior.

The resulting webs were also corona charged by using 4 pinner bars (Simco Corporation). The webs were charged on the face, back, back, and face again continuously at 50 KV and a distance of 5 cm from the web.

The samples were tested for filtration efficiency using a Model 8130 Automated Filter Tester manufactured by TSI Incorporated. The test involved challenging the nonwoven material with salt particles having a particle size distribution with a count median diameter of 0.075±0.020 μm and a standard geometric deviation not exceeding 1.86 in an aerosol at room temperature (about 25° C.) and a relative humidity of about 30%. The testing was conducted at a flow rate of 32 L/min with a flat surface area of 100 cm², and the results are set forth in Table 1 below.

TABLE 1

| | Pressure Drop | Efficiency |
|---|---|---|
| Sample | (Pa) | (%) |
| 1 | 10.0 | 92.6 |
| 2 | 7.6 | 84.8 |
| 3 | 8.0 | 85.4 |

The above data illustrated that the blended monocomponent and bicomponent fibers can form a nonwoven having a pressure drop and filtration efficiency that is similar to commercially-available filters with a MERV (Minimum Efficiency Reporting Value) rating of 13, which typically have a pressure drop of about 6.0-10 Pa and a filtration efficiency of about 80%.

In a further experiment, polypropylene monocomponent staple fibers (30 micron) were combined with bicomponent segmented pie fibers (20 micron before splitting) consisting of 16 alternating segments of polypropylene and polylactic acid (50/50% of each by weight) to form a nonwoven web prepared by carding, crosslapping, and needle punching. The resulting web was also corona charged. The nonwoven web was prepared on a Treutschler card, and was crosslapped and needled. The needling density was kept at 60/cm² with a needle penetration of 12 mm by using a single barb conical needle.

Staple nonwoven webs having a basis weight of 100 g/m² were formed by the above process with both 10% by weight of the segmented pie fibers (Sample 03A) and 20% by weight of the segmented pie fibers (Sample 04A), with the remainder being polypropylene monocomponent fibers.

Samples were tested for filtration efficiency using a Model 8130 Automated Filter Tester manufactured by TSI Incorporated as described above. The testing was conducted for flat sheets at three different flow rates and the results are set forth in Table 2 below.

TABLE 2

| | Flow Rate: 32 L/min | | Flow Rate: 60 L/min | | Flow Rate: 85 L/min | |
|---|---|---|---|---|---|---|
| Sample | | Efficiency | | Efficiency | | Efficiency |
| ID | ΔP (Pa) | (%) | ΔP (Pa) | (%) | ΔP (Pa) | (%) |
| 03A | 3.1 | 67.3 | 4.8 | 57.3 | 7.1 | 53.6 |
| 04A | 19.6 | 74.9 | 41.9 | 70.8 | 52.4 | 64.8 |

As expected, the sample with the lower amount of bicomponent fibers had a lower pressure drop and lower filtration efficiency.

In further testing, staple nonwoven webs having a basis weight of 100 g/m² were again formed by the above process with both 10% by weight of the segmented pie fibers (Sample 05B) and 20% by weight of the segmented pie fibers (Sample 06B), with the remainder being polypropylene monocomponent fibers. Samples of the same two staple nonwoven webs were pleated using two different pleat frequencies: 15 and 20 pleats/ft. The filter size was 24×24×2 inches. A wire backing was laminated to the structure to allow for pleating. The pleating essentially bends the wire backing to form a pleated structure.

The pleated nonwoven webs were tested using the ANSI/ASHRAE Standard 52.2-2017 (Method of Testing General Ventilation Air-Cleaning Devices for Removal Efficiency by Particle Size). This test involves use of a challenge aerosol of known particle size covering twelve required particle size ranges. The challenge aerosol is injected into the test duct and particle counts are taken for each of the size data points. The filter's performance, on each of the twelve particle sizes, during the six test cycles is determined. The filtration efficiency is stated as a ratio of the downstream-to-upstream particle count. The lowest values over the six test cycles are then used to determine the Composite Minimum Efficiency Curve. The twelve size ranges are placed in three larger groups according to the following schedule: ranges 1-4 (or E1, which is 0.3 to 1.0 μm), ranges 5-8 (or E2, which is 1.0 to 3.0 μm), and ranges 9-12 (or E3, which is 3.0 to 10.0 μm). Averaging the Composite Minimum Efficiency for each of these groups will calculate the average Particle Size Efficiency (PSE), and the resulting three percentages (E1, E2, E3) are then used to determine the MERV (Minimum Efficiency Reporting Value). The testing was conducted at an air velocity of 492 ft/min. The results are set forth in Table 3 below.

TABLE 3

| Sample | | E1 | E2 | E3 | | |
|---|---|---|---|---|---|---|
| ID | MERV | (%) | (%) | (%) | ΔP (Pa) | Pleats/ft. |
| 05B | 12 | 57 | 83 | 95 | 68 | 15 |
| 06B | 13 | 72 | 91 | 98 | 75 | 15 |
| 05B | 13 | 72 | 89 | 96 | 48 | 20 |
| 06B | 13 | 68 | 88 | 96 | 51 | 20 |

As shown, the testing confirmed that the nonwoven materials were able to achieve a MERV rating of 12-13, meaning the tested nonwoven materials are suitable for use in forming high efficiency HVAC filters. The nonwoven material with 20% of the bicomponent fibers was able to out-perform the 10% bicomponent sample at the 15 pleats/ft level, but the performance of both samples was very similar at the 20 pleats/ft level. Sample 05 with 15 pleats was a MERV 12 filter while at 20 pleats, its rating increase to MERV 13. Sample 06 was rated at MERV 13 with both 15 and 20 pleats, but as expected, had a lower pressure drop at 20 pleats/ft.

### Example 2—Spunbond Nonwoven Webs

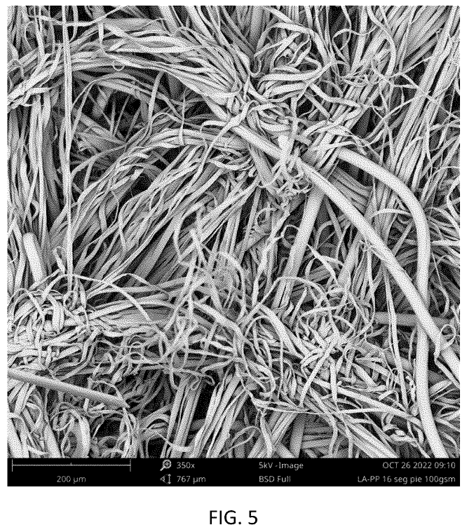

Polypropylene monocomponent continuous filament fibers (30 micron; 85% by weight of nonwoven) were combined with bicomponent segmented pie continuous filament fibers (20 micron before splitting; 15% by weight of nonwoven) consisting of 16 alternating segments of polypropylene and polylactic acid (90% by weight polypropylene per segmented pie fiber) to form a nonwoven web prepared by spunbonding. The monocomponent filaments and the bicomponent filaments were extruded through the same spinneret in a row pattern (segmented pie, monocomponent and segmented pie) and subjected to hydroentangling with a total of 6 injectors/manifolds and one prewet manifold. The jet strip nozzle spacing used was 1200, 1200, 1200, 1200, 1200 1200, and 600 microns respectively for the prewet and the additional six injectors. The pressures used were 30, 100, 100, 125, 125, 100, 125 bar respectively. Samples having a basis weight of 50, 100, and 125 g/m² were prepared. An SEM image of a 100 g/m² sample is shown in FIG. 5.

Samples were tested for filtration efficiency using a Model 8130 Automated Filter Tester manufactured by TSI Incorporated as described above. The testing was conducted on single layer and double layer samples. The testing was conducted on flat sheets at a flow rate of face velocity of 5.3 cm/s (32 L/min for an area of 100 cm²) and the results are set forth in Table 4 (single layer) and Table 5 (double layer) below.

TABLE 4

| Sample | Pressure Drop | Efficiency |
|---|---|---|
| (one layer) | (Pa) | (%) |
| 50 g/m² | 2.4 | 48.02 |
| 100 g/m² | 24 | 86.98 |
| 125 g/m² | 36 | 92.63 |

TABLE 5

| Sample | Pressure Drop | Efficiency |
|---|---|---|
| (two layers) | (Pa) | (%) |
| 100 g/m² | 4.7 | 73.34 |
| 200 g/m² | 49 | 98.31 |
| 250 g/m² | 72 | 99.51 |

The test results illustrate that using a continuous filament spunbonded material with a combination of monocomponent and bicomponent fibers can achieve the same high levels of filtration efficiency shown above for the staple fiber embodiments. Pressure drops tended to be higher for the spunbond embodiments as compared to the staple fiber embodiments. This is likely a result of the greater degree of fiber entanglement/densification that occurs after hydroentangling as compared to needling. The test results clearly show that the spunbonded embodiments can be optimized to the same filtration and pressure drop levels shown for the staple fiber embodiments, using techniques such as adjusting bicomponent percentage and/or hydroentangling intensity, or by using multiple layers.

Interestingly, the use of double layers having a total gsm in the 200-250 range produced filtration efficiencies in the MERV 16 and HEPA range, at a lower pressure drop than seen with many commercially-available filters of those types. This shows that the inventive concept can be extended to the optimization of air filters having filtration efficiency across the entire spectrum of high performing filters, from MERV 12 to MERV 16 and even into the HEPA/ULPA filter range.

In a further study, polypropylene monocomponent continuous filament fibers (30 micron; 85% by weight of nonwoven) were combined with bicomponent segmented pie continuous filament fibers (20 micron before splitting; 15% by weight of nonwoven) consisting of 16 alternating segments of polypropylene and polylactic acid (90% by weight polylactic acid per segmented pie fiber) to form a nonwoven web prepared by spunbonding. The monocomponent filaments and the bicomponent filaments were extruded through the same spinneret in a row pattern (segmented pie, monocomponent and segmented pie) and subjected to hydroentangling with a total of 6 injectors/manifolds and one prewet manifold. The jet strip nozzle spacing used was 1200, 1200, 1200, 1200, 1200 1200, and 600 microns respectively for the prewet and the additional six injectors. The pressures used were 30, 100, 100, 125, 125, 100, 125 bar respectively. Samples having a basis weight of 50, 100, and 125 g/m² were prepared.

Samples were tested for filtration efficiency using a test set forth in 42 CFR Part 84 and NIOSH Procedure No. TEB-APR-STP-0059, which was conducted using a Model 8130 Automated Filter Tester manufactured by TSI Incorporated as described above. The testing was conducted on single layer and double layer samples. The testing was conducted for flat sheets at a face velocity of 5.3 cm/s at a flow rate of 32 L/min for a sample measuring 100 cm² and the results are set forth in Table 6 (single layer) and Table 7 (double layer) below.

TABLE 6

| | Pressure Drop | Efficiency |
|---|---|---|
| Sample | (Pa) | (%) |
| 50 g/m² | 2.8 | 47.83 |
| 100 g/m² | 15.7 | 80.80 |
| 125 g/m² | 19.8 | 86.26 |

TABLE 7

| | Pressure Drop | Efficiency |
|---|---|---|
| Sample | (Pa) | (%) |
| 100 g/m² | 5.7 | 72.43 |
| 200 g/m² | 31.0 | 96.32 |
| 250 g/m² | 39.9 | 98.12 |

These test results illustrate that switching the bicomponent fibers from mostly polypropylene to mostly polylactic acid did not significantly reduce filtration efficiency, but did reduce pressure drop. This indicates that the percentage of each polymer in the bicomponent fiber is not critical to filtration performance, but changing the percentage can provide another means to optimize a desired pressure drop/filtration efficiency combination.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A nonwoven material comprising a blend of a first plurality of monocomponent fibers and a second plurality of segmented fibers comprising segments comprising a first polymer and segments comprising a second polymer different from the first polymer, wherein the nonwoven material comprises about 75 to about 95% by weight of the monocomponent fibers, and about 5 to about 25% by weight of the segmented fibers, based on the total weight of the nonwoven material, and wherein the segmented fibers are at least partially fibrillated or split.

2. The nonwoven material of claim 1, wherein the first polymer is an aliphatic polyester and the second polymer is an aromatic polyester or a polyolefin, or the first polymer is a polyolefin and the second polymer is a polyamide.

3. The nonwoven material of claim 1, wherein the first polymer is polylactic acid and the second polymer is polypropylene or polyethylene.

4. The nonwoven material of claim 1, wherein the weight ratio of the first polymer to the second polymer within the segmented fibers is 1:10 to 10:1.

5. The nonwoven material of claim 1, wherein the monocomponent fibers comprise either the first polymer or the second polymer.

6. The nonwoven material of claim 1, wherein the monocomponent fibers comprise polypropylene or polyethylene.

7. The nonwoven material of claim 1, wherein the segmented fibers are segmented ribbon, segmented pie, tipped multilobal, or segmented cross fibers.

8. The nonwoven material of claim 1, wherein the segmented fibers are segmented pie fibers having 2 to about 64 segments.

9. The nonwoven material of claim 1, wherein the segmented fibers are segmented pie fibers having about 10 to about 30 segments.

10. The nonwoven material of claim 1, wherein the nonwoven material has a basis weight of about 50 to about 300 g/m² and/or a pressure drop of about 5 to about 80 Pa and/or a filtration efficiency of about 80% or higher, on a TSI 8130 filter tester at a flow rate of 32 L/min and a sample area of 100 cm².

11. The nonwoven fabric of claim 1, wherein the monocomponent fibers and the segmented fibers are continuous filament fibers.

12. The nonwoven fabric of claim 1, wherein the monocomponent fibers and the segmented fibers are discontinuous fibers having a length ranging from 3 mm to 150 mm.

13. An air filter comprising the nonwoven material of claim 1.

14. The air filter of claim 13, wherein the nonwoven material is pleated, optionally wherein the nonwoven material has about 10 to about 25 pleats/ft.

15. The air filter of claim 13, wherein the air filter further comprises a frame attached to the nonwoven material.
